(19) United States
(12) Patent Application Publication
(10) Pub. No.: US 2004/0179250 A1
(43) Pub. Date: Sep. 16, 2004

(54) Image reading apparatus

(75) Inventors: Tatsuya Konagaya, Kanagawa (JP); Tsuyoshi Tanabe, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/798,429

(22) Filed: Mar. 12, 2004

(30) Foreign Application Priority Data
Mar. 13, 2003 (JP) 2003-67689

(51) Int. Cl. G03B 1/00; H04N 1/46

(52) U.S. Cl. 358/506; 358/509

(57) ABSTRACT

In order to reduce time required for inputting images of a film, an image reading apparatus comprising a first detecting section which detects starting positions of respective frame images of the film and positions of marks, a storing section which sets and stores, on the basis of the starting positions and the positions of the marks detected by the first detecting section, a position of a frame corresponding mark, which corresponds to the starting position, every each of the frame images, a second detecting section, provided at downstream side of the first detecting section, which detects the position of the frame corresponding mark every each of the frame images and an image reading section which reads each of the image frames in order of frame number thereof on the basis of the stored contents in the storing section and detection data detected by the second detecting section, is provided.

### CROSS-REFERENCE TO RELATED APPLICATION

This application claims priority under 35 USC 119 from Japanese Patent Application No. 2003-67689, the disclosure of which is incorporated by reference herein.

### BACKGROUND OF THE INVENTION

1. Field of the Invention

The present invention relates to an image reading apparatus which reads an image of a film, further in detail, relates to an image reading apparatus by which time required to input images of a film is reduced.

2. Description of the Related Art

As shown in FIG. 8, in a case in which a printing operation for printing a (photographic) printing paper or the like is carried out with using a negative film which is subject to developing, each of positions of frames is detected by a frame position detecting section 92 while the film is conveyed by a carrier 90, and a printing light from a light source is exposed, via the negative film, on the printing paper or the like by operating a printing operation key.

At this time, formerly, only one negative film is set to the negative film carrier and the set negative film is conveyed. Accordingly, in a case in which successively printing is carried out for a plurality of the negative films, it is necessary for an operator to set one negative film to the carrier and operate the printing operation key every each of the negative films.

In order to eliminate such annoyance, examples in which a plurality of negative films are set and the set negative films are successively supplied to a printing device automatically are disclosed. (See, for example, Japanese Patent No. 2693048, Japanese Patent Application Laid-Open (JP-A) No. 4-254845, Japanese Patent Application Laid-Open (JP-A) No. 4-257855, Japanese Patent Application Laid-Open (JP-A) No. 4-264541 and Japanese Patent No. 2669568.)

Japanese Patent No. 2693048 discloses a negative film supplying device in which a film holding section can be moved or is fixed. The negative film supplying device supplies a negative film by moving negative film picking up means. Japanese Patent Application Laid-Open (JP-A) No. 4-254845 discloses a device, which is obtained by varying the device disclosed in Japanese Patent No. 2693048. The device is a negative film supplying device in which a film holding section is driven to circulate. Japanese Patent Application Laid-Open (JP-A) No. 4-257855 discloses a device, which is obtained by varying the device disclosed in Japanese Patent No. 2693048. The device is a negative film supplying device in which a holding section of films in a state of laminating is moved downward. Japanese Patent Application Laid-Open (JP-A) No. 4-264541 discloses a device, which is obtained by varying the device disclosed in Japanese Patent No. 2693048. The device is a negative film supplying device in which a film holding section is attached to a rotation drum. Japanese Patent No. 2669568 discloses what is called an automatic negative film feeder.

However, even if negative films are supplied automatically, in the film supplying device in which high speed processing is carried out, it is desired to further reduce time required for inputting images.

Not only in a case in which a mini laboratory of analog type, in which light transmitted through a negative film is directly exposed on a photosensitive material, is used, but also in a case in which a mini laboratory of digital type in which, after image information on a film is picked up once by a CCD element, exposing is carried out separately, is used, it is also desired to further reduce time required for inputting images.

The inventors note a fact that there is often a case in which a period from a time at which a film is supplied to a time at which scanning of the film is carried out is long. Then, the inventors find as follows.

In a conveyance path within a carrier (a film carrier), a distance, from a frame position detecting section which detects a position of a frame to an image reading section which read a frame (an image), is short. Therefore, detection of position of frame can be carried out at a position which is apart from the image reading position with a distance corresponding to only three or four frames. Therefore, in the conventional carrier, in a case in which three or four frames or more whose positions cannot be detected due to exposure failure or the like continuously exist in a negative film, reading of those frames are skipped. Then, when a frame whose position can be detected is detected, in order to prevent occurrence of error of feeding amount of the negative film, a conveyance direction of the negative film is made to reverse. Due to the conveyance of the negative film in the reverse direction, a required time from a time at which the negative film is supplied to a time at which scanning of the negative film is carried out becomes very long.

Further, not only in a case of the negative film, but also in a case of a black and white film or a sepia film, a similar phenomenon occurs.

### SUMMARY OF THE INVENTION

In view of the aforementioned, an object of the present invention is to provide an image reading apparatus by which time required for inputting images of a film is reduced.

The inventors of the present invention study reducing a time required for inputting images by structure in which it is not necessary to convey the film in a reverse direction, and complete the present invention.

A first aspect of the present invention is an image reading apparatus comprising a film set section at which a film is set and from which the set film is fed; a first detecting section which detects starting positions of respective frame images of the film fed from the film set section, and positions of marks formed outside the respective frame images; a storing section which sets and stores, on the basis of the starting positions of the respective frame images and the positions of the marks detected by the first detecting section, a position of a frame corresponding mark, which corresponds to the starting position, every each of the frame images; a second detecting section, provided at downstream side of the first detecting section, which detects the position of the frame corresponding mark every each of the frame images; and an image reading section which reads each of the image frames in order of frame number thereof on the basis of the stored contents in the storing section and detection data detected by the second detecting section.

A number of films which can be set at the film set section is not limited. That is, only one film may be set at the film set section, or a plurality of the films may be set at the film set section. In a case in which a plurality of the films can be set at the film set section, after image reading of a first film is finished, images of the next film can be immediately read. Therefore, this case has a merit for high speed processing of image inputting. Further, type of the film is not limited to the negative film. The film can be a reversal film (a positive film), a black and white film, a sepia film or the like. It is preferable that the second detecting section is provided within a film carrier in a point of efficiency of conveyance of the film.

With considering of reducing a time required for detecting and minimizing the apparatus, it is preferable that the first detecting section is provided at a position, at a downstream side of the film set section, at which it is possible to detect the film fed out immediately after from the film set section. Further, with considering of easiness to form the marks on the film, it is preferable that the marks are formed at side end portion(s) of the film.

In the film fed from the film set section, the first detecting section detects the starting positions and the positions of the marks every each of the frame images.

Then, the storing section calculates and stores, on the basis of the starting positions and the positions of the marks which are read, the position of the frame corresponding mark, which corresponds to the starting position, every each of the frame images.

Further, the second detecting section detects the position of the frame corresponding mark every each of the frame images, and transmits them to the image reading section. The image reading section reads image frames subsequently on the basis of the positions of the frame corresponding marks stored in the storing section.

As a result, in the present invention, it is not necessary to convey the film in the reverse direction, which is necessary in the conventional apparatus. Therefore, a time required for detecting position of frames can be reduced very much, and a time required for inputting images can be reduced very much.

In a second aspect of the present invention, the storing section estimates and stores a starting position of a frame image which cannot be detected by the first detecting section, and a position of a frame corresponding mark which corresponds to the starting position of the frame image which cannot be detected by the first detecting section, on the basis of a starting position of a frame image of the film, which can be detected by the first detecting section, and a position of a frame corresponding mark, which corresponds to the starting position of the frame image which can be detected by the first detecting section.

As a result, even in a case in which a frame image whose starting position cannot be detected by the first detecting section exists, because the storing section estimates and stores the starting position of this frame image which cannot be detected by the first detecting section, the image reading section can read this frame image which cannot be detected by the first detecting section without conveying the film in the reverse direction. Generally, in films, dimensions of image frames of the films are in common, also intervals between adjacent image frames of the films are in common. Therefore, as long as one frame image (a starting position thereof) can be read, starting positions and positions of frame corresponding marks of all other frame images can be estimated.

In a third aspect of the present invention, the mark formed outside the frame image is a perforation formed at the film.

As a result, it is not necessary to further form marks on the film. Moreover, image information can be smoothly read at the image reading section. The mark may be a bar code.

In a fourth aspect of the present invention, the image reading apparatus further comprises a determining section which determines at least one of direction of a surface of the film (that is, an obverse face or a reverse face) and type of the film.

A position of the determining section may be a position immediately after the first detecting section, or a position at slightly upstream side of the second detecting section.

In the fourth aspect of the present invention, before image scanning is performed, one of or both of a direction of a surface of the film, that is, an obverse face or a reverse face and type of the film can be judged. Therefore, it is possible to reduce a time required for judging a direction of a surface of the film (an obverse face or a reverse face) and type of the film. Further, in a case in which the type of the film is judged and it is transmitted to the image reading section, a mode in the image reading section can be changed in advance by a time at which the film arrived at the reading position of the image reading section. Therefore, it is possible to reduce a time required for changing the mode very much. Here, “changing mode” means, for example, that a CCD accumulation charge number is changed in a case of light emitted from a light source being green light.

In a fifth aspect of the present invention, the determination is made by the determining section by detection of a bar code provided at the film.

In this case, the determining section often includes a bar code detecting sensor.

In the fifth aspect of the present invention, In a case of a film at which a bar code is attached (such as a negative film, a sepia film or the like) judging of a direction of a surface of the film (that is, an obverse face or a reverse face) and type of the film can be carried out by detecting the bar code.

In a case of a film at which a bar code is not attached, that is, in a case of a black and white film, it is possible to judge whether the film is a black and white film or a color film by detecting silver on the film by using an infrared light seosor.

In a sixth aspect of the present invention, the determination is made by the determining section by detecting silver on the film with infrared light.

In this case, the determining section often includes an infrared light sensor. In the sixth aspect of the present invention, it is possible to determine the type of the film surely and promptly.

Further, in order to read image with high accuracy and in a short time, it is preferable to carry out pre-scanning of the image before carrying out fine scanning of the image, reading the image finely.

In a seventh aspect of the present invention, the image reading apparatus further comprises a pre-scanning section, provided at upstream side of the image reading section, which carries out a pre-scanning of the film.

As a result, it is not necessary to carry out the pre-scanning at the image reading section, therefore, a time required for reading image can be reduced.

With considering minimizing of the apparatus, it is preferable that a position at which the pre-scanning section is provided is a position which is at a downstream side of the film set section and at which it is possible to detect the film fed out immediately after from the film set section, or a position within the film set section.

It is possible that the pre-scanning section is provided with a densitometer which measures density of a film, and the pre-scanning is carried out. Further, It is possible that the pre-scanning section is provided with an image sensor of liner type or area type, and the pre-scanning is carried out on the basis of measured value obtained by the image sensor. The structure and/or operation of the pre-scanning section is not limited.

An eighth aspect of the present invention is an image reading apparatus comprising a film set section at which a film is set and from which the set film is fed; a first detecting section which detects starting positions of respective frame images of the film fed from the film set section, and positions of marks formed outside the respective frame images; a storing section which sets and stores, on the basis of the starting positions of the respective frame images and the positions of the marks detected by the first detecting section, a position of a frame corresponding mark, which corresponds to the starting position, every each of the frame images; a second detecting section, provided at downstream side of the first detecting section, which detects the position of the frame corresponding mark every each of the frame images; and an image reading section which reads each of the image frames, without the film being conveyed to the reverse direction, on the basis of the stored contents in the storing section and detection data detected by the second detecting section.

### BRIEF DESCRIPTION OF THE DRAWINGS

FIG. 1 is a perspective view of an image reading apparatus relating to a first embodiment of the present invention.

FIG. 2 is a side cross sectional view showing a structure of the image reading apparatus relating to the first embodiment of the present invention.

FIG. 3 is a perspective view showing a negative film setter of the image reading apparatus relating to the first embodiment of the present invention (showing a state in which three films are set).

FIG. 4 is a plan view of the negative film.

FIG. 5 is a side cross sectional view showing a structure of an image reading apparatus relating to a second embodiment of the present invention.

FIG. 6 is a side cross sectional view showing a structure of an image reading apparatus relating to a third embodiment of the present invention.

FIG. 7A is a flow chart showing processes carried out by an image reading apparatus relating to a fourth embodiment of the present invention (first film).

FIG. 7B is a flow chart showing processes carried out by an image reading apparatus relating to a fourth embodiment of the present invention (second film).

FIG. 7C is a flow chart showing processes carried out by an image reading apparatus relating to a fourth embodiment of the present invention (third film).

FIG. 8 is a plan view showing a structure of a carrier of a conventional image reading apparatus.

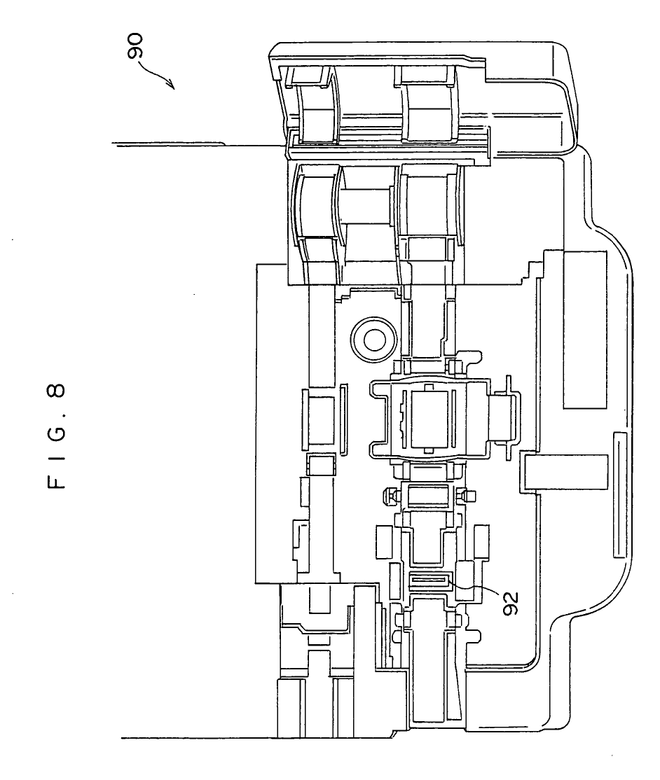

### DETAILED DESCRIPTION OF THE INVENTION

Hereinafter, embodiments, in which an image of a negative film as a film is read, of the present invention will be described in detail. In a second embodiment and a third embodiment, the same reference numerals are applied to the same components, members and structures as those of a first embodiment and the descriptions thereof are omitted. In a fourth embodiment, the same reference numerals are applied to the same components, members and structures as those of the second embodiment and the descriptions thereof are omitted.

[First Embodiment]

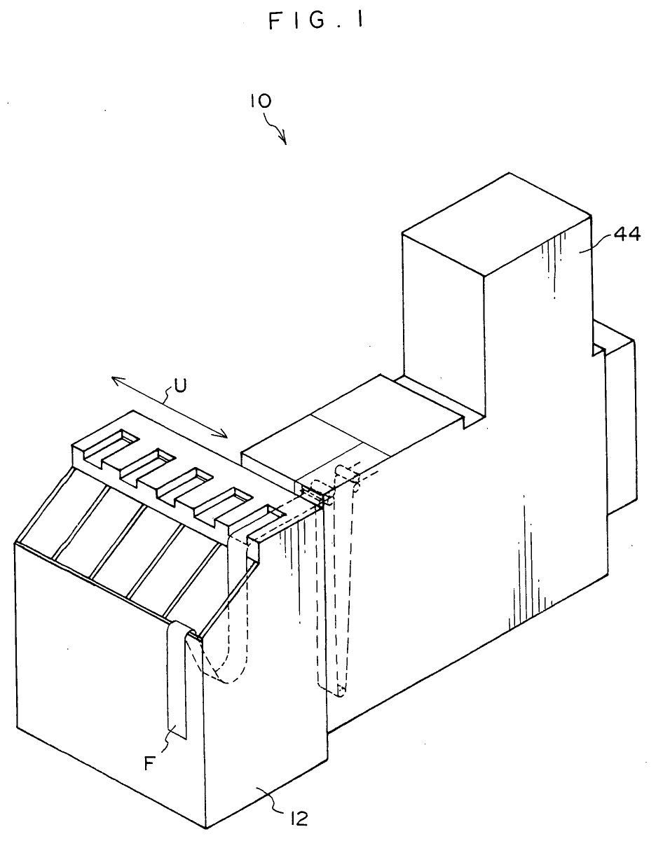

As shown in FIGS. 1-4, an image reading apparatus 10 relating to the first embodiment has a negative film setter 12. A plurality of negative films F (hereinafter, film(s) F) can be set in the negative film setter 12. The negative film setter 12 can move in a sliding manner in a direction shown by an arrow U in FIG. 1, thereby the films F are successively fed out.

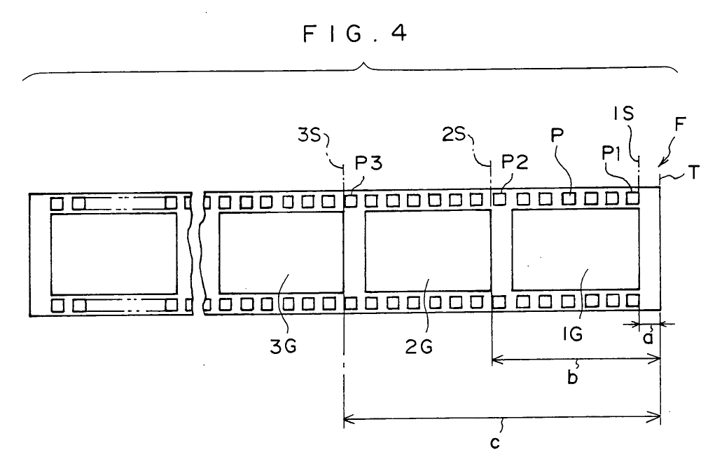

Further, the image reading apparatus 10 has a first detecting section 14. The first detecting section 14 is disposed at a position at a downstream side (at a side of a film feeding out port) of the negative film setter 12, at which it is possible to detect the film F immediately after fed out from the negative film setter 12. As shown in FIG. 4, the first detecting section 14 detects a starting position of each of image frames of the film F being conveyed (for example, a starting position 1S, 2S, 3S) and positions of all perforations P formed at a side end portion of the film F. Information of the positions is sent to a storing section 48 of an image reading section 44 which will be described later.

Further, the image reading apparatus 10 has a negative film reservoir 18 which accommodates the film F at the downstream side of the first detecting section 14.

The negative film reservoir 18 has a reservoir main body 20, a pair of feeding rollers 22A and 22B and a pair of feeding rollers 22C and 22D. The reservoir main body 20 has an elongate (longitudinal) configuration. The pair of the feeding rollers 22A and 22B nip the film F which is conveyed from the first detecting section 14 to feed (convey) it. The pair of the feeding rollers 22C and 22D are provided at the downstream side of the pair of the feeding rollers 22A and 22B. The dimension of the reservoir main body 20 is determined such that the reservoir main body 20 can accommodate the film F even if the film F is very long.

The feeding roller 22D is movable upward and downward such that switching between a state in which the film F is sandwiched between the feeding rollers 22C and 22D and a state in which the film F is not sandwiched between the feeding rollers 22C and 22D can be carried out. Further, The negative film reservoir 18 has a film pushing down roller 24. The film pushing down roller 24 is provided at a central portion of the reservoir main body 20 and can move from a top portion to a bottom portion of the reservoir main body 20. The film F can be accommodated within the reservoir main body 20 due to the film pushing down roller 24.

Further, the image reading apparatus 10 has a negative film feeder 26 connected to the downstream side of the negative film reservoir 18. The negative film feeder 26 has an upstream side leading and back ends detecting sensor 30 and a downstream side leading and back ends detecting sensor 32 in order to prevent the films from striking against each other when a plurality of the films are conveyed successively. The negative film feeder 26 has feeding rollers 34, 35 and 36 provided between the upstream side leading and back ends detecting sensor 30 and the downstream side leading and back ends detecting sensor 32. The film is conveyed while forming sag (loop) by the feeding rollers 35 and 36.

Further, the image reading apparatus 10 has a carrier 40 connected to the downstream side of the negative film feeder 26. The carrier 40 has a second detecting section 42 which detects positions of all perforations P. Further, the carrier 40 has a carrier inside sensor 46. A negative film catcher 50, which will be described later, feed out the film to a negative film receiving box 54 after the film passes the carrier inside sensor 46.

Further, the image reading apparatus 10 has an image reading section 44. The image reading section 44 reads an image of the film F being conveyed, at a position of the downstream side of the second detecting section 42.

The image reading section 44 is provided with the storing section 48. The storing section 48 has calculating function and stores data. The storing section 48 receives information of each of the starting positions of the image frames and each of the positions of the perforations from the first detecting section 14. Then, the storing section 48 calculates a position of the perforation corresponding to each of the starting positions of the image frames (hereinafter, position of “frame corresponding perforation”), and stores them.

Here, the frame corresponding perforation can be defined as a perforation which is positioned nearest the starting position of the image frame. Further, for example, the frame corresponding perforation can be defined as a perforation which is positioned nearest the starting position of the image frame and which is positioned at a film-leading end side of the starting position. However, definition of the frame corresponding perforation is not limited to the same.

Concrete example will be explained. As shown in FIG. 4, first, the first detecting section 14 detects the starting positions of all of the image frames of the film F and positions of all of the perforations P formed at the side end portion of the film F. Then, the storing section 48 receives the data from the first detecting section 14, and sets the positions of the frame corresponding perforations, which correspond to the respective starting positions of the image frames (for example, a position of a frame corresponding perforation P1 of an image frame 1G, a position of a frame corresponding perforation P2 of an image frame 2G and a position of a frame corresponding perforation P3 of an image frame 3G), and stores them. At this time, the storing is carried out such that a time period, from a time at which a k-th perforation arrives at the first detecting section 14 to a time at which the starting position 1S of the image frame 1G whose frame number is 1 arrives at the first detecting section 14, a time period, from a time at which a m-th perforation arrives at the first detecting section 14 to a time at which the starting position 2S of the image frame 2G whose frame number is 2 arrives at the first detecting section 14, a time period, from a time at which a n-th perforation arrives at the first detecting section 14 to a time at which the starting position 3S of the image frame 3G whose frame number is 3 arrives at the first detecting section 14, are stored, where k, m and n are natural numbers satisfying “k<m<n”.

Because it is easy to detect perforations, the first detecting section 14 can surely detect all perforations. On the other hand, there may be a case in which the first detecting section 14 cannot detect the starting position of the image frame due to exposure failure or the like. In this case, the storing section 48 estimates a starting position of an image frame which cannot be detected by the first detecting section 14 and a position of a frame corresponding perforation corresponding thereto, on the basis of a starting position of an image frame of the film, which can be detected by the first detecting section 14 and a position of a frame corresponding perforation corresponding thereto. Then, the estimated results are stored.

Concrete example will be explained. As shown in FIG. 4, relationship among an interval a, an interval B and interval c is:

b=a+(c−a)/2

where the interval a is a distance from a tip end T of the film F to the starting position 1S, the interval B is a distance from the tip end T of the film F to the starting position 2S, and the interval c is a distance from the tip end T of the film F to the starting position 3S.

Accordingly, for example, in a case in which the image frame 2G, whose image frame number is 2, cannot be read due to exposure failure or the like, that is, in a case in which the starting position 2S cannot be read, the storing section 48 estimates the starting position 2S by using the above mentioned relational expression and stores it, together with this, the storing section 48 estimates the position of the frame corresponding perforation P2 corresponding to the starting position 2S and store it.

The image reading section 44 having such storing section 48 receives the detected data of all of the perforations P from the second detecting section 42, checks up and compares the detected data with the stored contents of the storing section 48, and reads each of the images of the image frames every each of image frame numbers.

The negative film catcher 50 is connected at the downstream side of the image reading section 44. The negative film receiving box 54 is connected at the downstream side of the negative film catcher 50. In the negative film catcher 50, a feeding out trigger sensor 56 is provided.

Hereinafter, an operation in which the image of the film is read by the image reading apparatus 10 will be described.

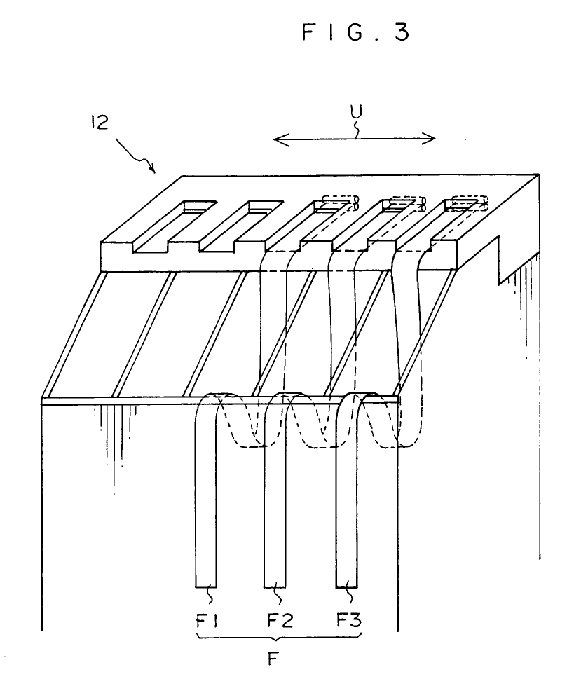

First, the film F to be subject to the image reading processing is set at the negative film setter 12. At this time, the feeding roller 22D is made be moved downward. At this time, a plurality of the films can be set. (For example, as shown in FIG. 3, each of three films F1, F2 and F3 may be set.)

Then, the first film F1 is fed from the negative film setter 12. Then, the first detecting section 14 detects the starting position of each of the image frames and all of the perforations P, and the detected data is sent to the storing section 48. A feeding speed of the film at the first detecting section 14 is, for example, 330 mm/s.

The storing section 48, on the basis of the detected data sent from the first detecting section 14, every each of the image frames, sets positions of frame corresponding perforations (the frame corresponding perforations P1, P2 and P3 and the like) which correspond to the respective starting positions, and stores them. At this time, in a case in which a starting position which cannot be detected by the first detecting section 14 exists, as described above, the storing section 48 estimates the starting position which cannot be detected by the first detecting section 14 and store it on the basis of starting position(s) of the film F which can be detected by the first detecting section 14 and position(s) of frame corresponding perforation(s) corresponding thereto.

Further, together with the film F being conveyed by the feeding rollers 22A and 22B, the feeding roller 22D is made to move upward thereby the film F is slightly nipped by the feeding rollers 22C and 22D.

Then, in accordance with the feeding speed of the film F, the film pushing down roller 24 is made to move downward. As a result, after the back end of the film F passes through the first detecting section 14, the film F is accommodated within the negative film reservoir 18.

The film F conveyed from the negative film reservoir 18 is conveyed to the negative film feeder 26. In the negative film feeder 26, it is detected by the upstream side leading and back ends detecting sensor 30 that the film F passes therethrough. The film F is conveyed in a state in which sagging (loop) is added by the feeding rollers 35 and 36, and further, it is detected by the downstream side leading and back ends detecting sensor 32 that the film F passes therethrough. The detection signal from the upstream side leading and back ends detecting sensor 30 is sent to the negative film setter 12. When the negative film setter 12 receives this signal, the next film is fed.

The film F conveyed from the negative film feeder 26 is conveyed to the carrier 40. In the carrier 40, the second detecting section 42 detects successively all of the perforations P and the detection data is transmitted to the storing section 48.

In the image reading section 44, on the basis of the stored data stored in the storing section 48 (that is, each of the starting positions of the image frames and the frame corresponding perforations which correspond to them) and the detection data detected at the second detecting section 42, the images of each of the image frames are read every each of the image frames by setting scanning positions precisely.

As described above, in the first embodiment, on the basis of each of the starting positions of the image frames and the frame corresponding perforations which correspond to them stored in the storing section 48 and the detection data detected at the second detecting section 42, the image reading section 44 read the images of the film F successively. As a result, in a case in which an image frame, whose image cannot be read in the conventional image reading apparatus, exists, by corresponding it with a frame corresponding perforation thereof, the image reading section 44 precisely can estimate a starting position of this image frame, therefore the image of this image frame can be read. Accordingly, conventionally, it is necessary to convey the film F to the reverse direction in such a case, but it is not necessary to convey the film F to the reverse direction in the present embodiment. Therefore, the time required to detect the image frames can be reduced very much, and the time required to inputting images can be reduced very much.

Further, because the negative film reservoir 18 is provided, after a preceding film is sent out from the negative film reservoir 18, a leading perforation of a subsequent film is detected by the first detecting section 14 and the film can be made to wait at the negative film reservoir 18. Therefore, the films can be successively fed efficiently.

[Second Embodiment]

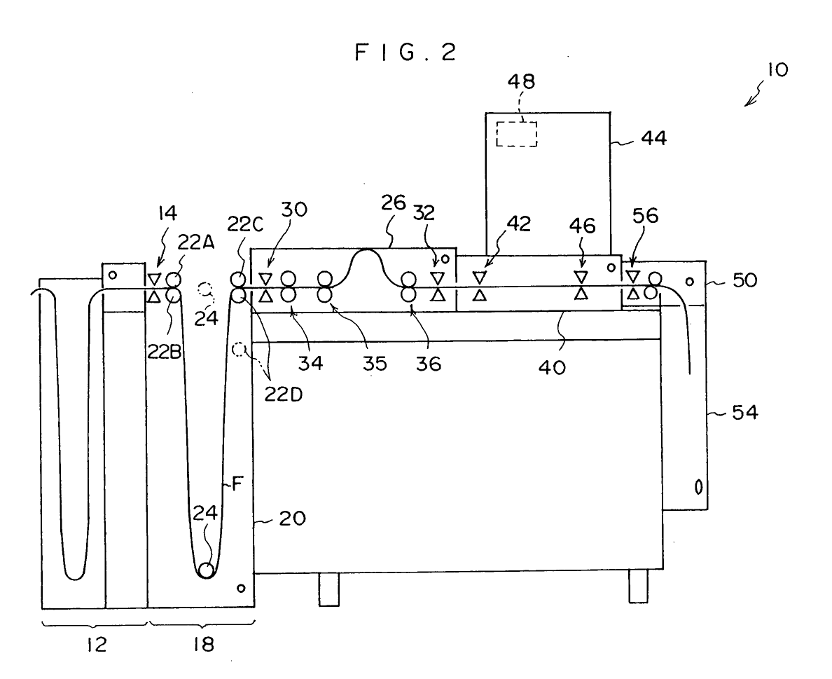

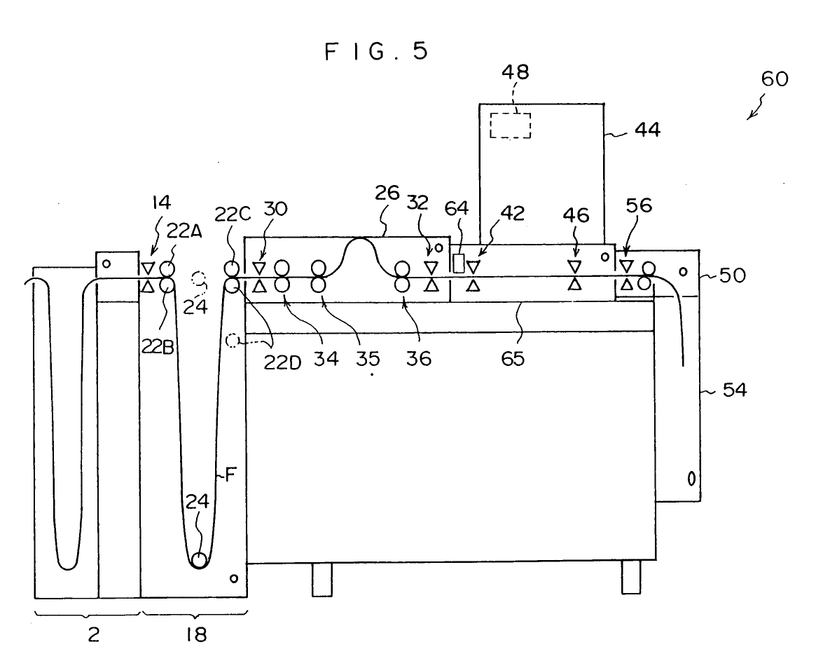

As shown in FIG. 5, in comparing an image reading apparatus 60 of a second embodiment with the image reading apparatus 10 of the first embodiment, instead of the carrier 40 (see FIG. 2)of the first embodiment, the image reading apparatus 60 is provided with a carrier 65 in which a determining section 64 is provided. The determining section 64 determines a type of a film and transmits it to the image reading section 44. As a result, by judging one of or both of (1) direction of a surface of the film, that is, an obverse face or a reverse face and (2) a type of the film before scanning is carried out in the image reading section 44, changing of mode of the image reading section 44 can be carried out while the film is conveyed. Therefore, the time required from a time of feeding the film F to be fed to a time at which the image reading processing is completed can be reduced very much.

It is also possible that the determining section 64 has a bar code detecting sensor, and by a bar code printed at a negative film being detected, direction of a surface of the film (that is, an obverse face or a reverse face) or a type of the film (a type such as a black and white film, a color film or the like) are determined.

Further, it is also possible that the determining section 64 further has an infrared light sensor, and a type of the film is determined speedy and surely by detecting silver on the film.

[Third Embodiment]

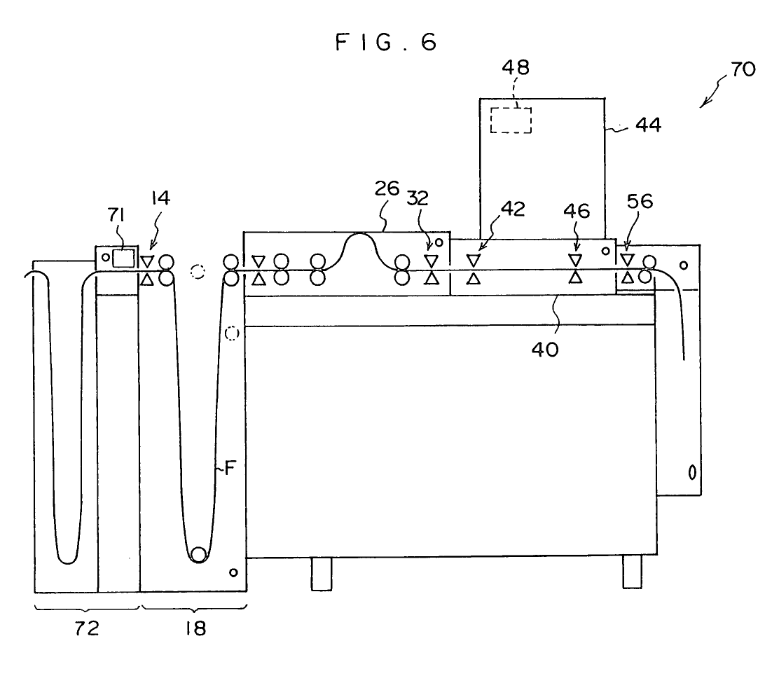

As shown in FIG. 6, in comparing an image reading apparatus 70 of a third embodiment with the image reading apparatus 10 of the first embodiment, instead of the negative film setter 12 (see FIG. 2) of the first embodiment, the image reading apparatus 70 is provided with a negative film setter 72 in which a pre-scanning section 71 is provided. The pre-scanning section 71 transmits scanning results to the image reading section 44.

As a result, it is not necessary to carry out pre-scanning at the image reading section 44. Therefore, the time required for reading of images can be reduced. Further, because the pre-scanning section 71 is provided in the negative film setter 72, it is possible to miniaturize the apparatus.

It is possible that the pre-scanning section 71 is provided with a densitometer which measures density of a film, and the pre-scanning is carried out by the density of the film being measured. Further, It is possible that the pre-scanning section 71 includes an image sensor of liner type or area type, and the pre-scanning is carried out by the image sensor.

[Fourth Embodiment]

In an image reading apparatus of a fourth embodiment, sequence (process) is further simplified compared with the second embodiment. That is, in the fourth embodiment, during scanning of a negative film, detection of positions of frames of a negative film to be scanned subsequently is completed.

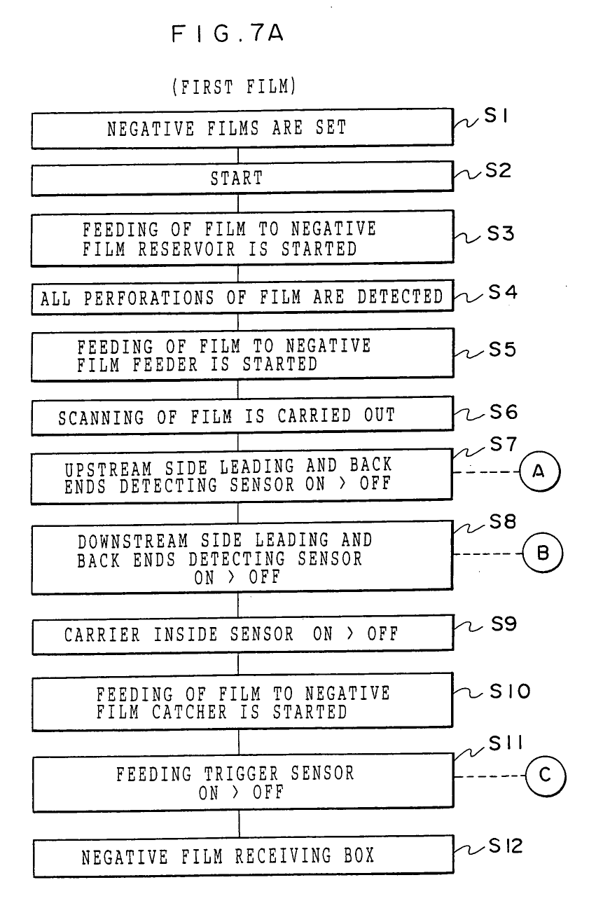

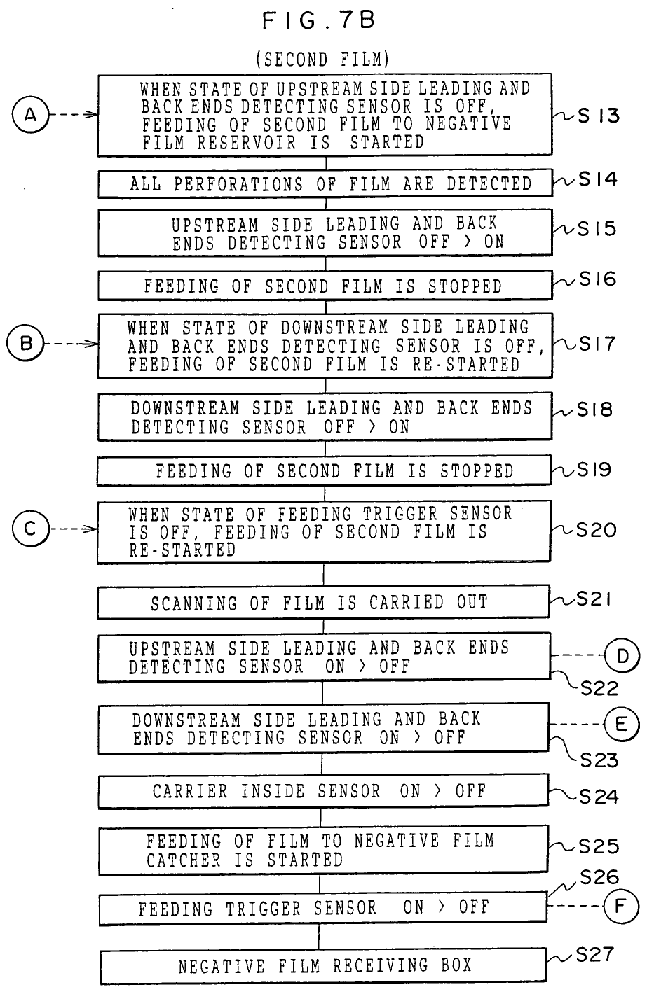

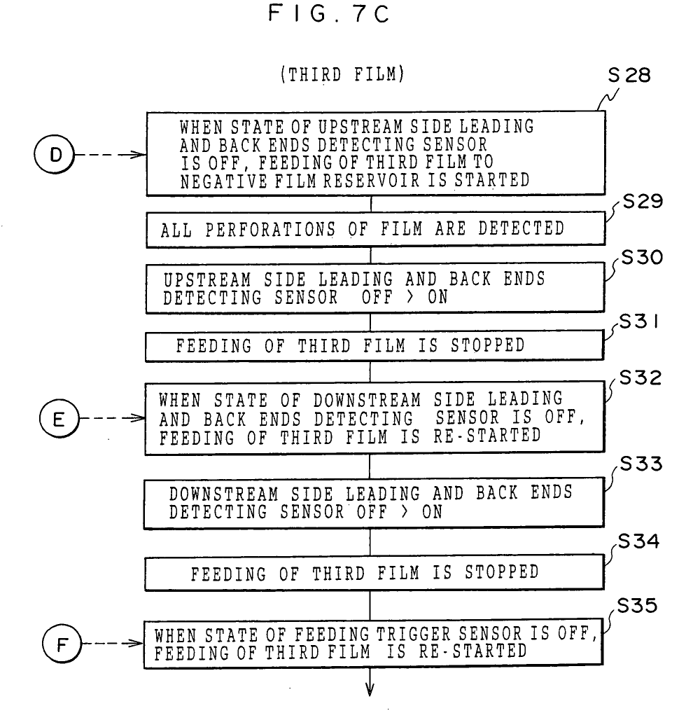

FIGS. 7A, 7B and 7C shows a flow chart showing processes carried out in the fourth embodiment of the present invention. In the fourth embodiment, first, a plurality of negative films are set at the negative film setter 12 (Step S1), and operation of the image reading apparatus is started (Step S2). As a result, a first negative film is fed from the negative film setter 12 to the negative film reservoir 18 (Step S3), and all of perforations of the first negative film are detected at the first detecting section 14 (Step S4). At this time, a bar code may be detected or pre-scanning may be carried out. When a back end of the film is detected at the first detecting section 14, the negative film setter 14 is moved such that a second film can be fed.

Thereafter, the film is fed to the negative film feeder 26 (Step S5), and scanning is carried out by the image reading section 44 while continuous conveyance of the film or intermittent conveyance of the film, in which the film is conveyed every each of frames, is carried out in the carrier 65 (Step S6). At this time, the determining section 64 determines type of the film, and the image reading section 44 changes mode of reading condition in accordance with the type of the film.

Further, state of the upstream side leading and back ends detecting sensor 30 is changed from ON to OFF (Step S7). Changing of the state of the upstream side leading and back ends detecting sensor 30 from ON to OFF means that the back end of the film finishes passing through the upstream side leading and back ends detecting sensor 30.

Further, state of the downstream side leading and back ends detecting sensor 32 is changed from ON to OFF (Step S8). Changing of the state of the downstream side leading and back ends detecting sensor 32 from ON to OFF means that the back end of the film completing passing through the downstream side leading and back ends detecting sensor 32.

Thereafter, state of the carrier inside sensor 46 is changed from ON to OFF (StepS9), then, the first film is fed to the negative film catcher 50 (Step S10). State of the feeding trigger sensor 56 is changed from ON to OFF (Step S11), then, the first film is accommodated in the negative film receiving box 54 (Step S12).

On the other hand, when the step 7 is carried out, this information is transmitted to the negative film setter 12, and the negative film setter 12 feeds the second film to the negative film reservoir 18 (Step S13). At this time, all of perforations are detected at the first detecting section 14 (Step S14). When a back end of the film is detected at the first detecting section 14, the negative film setter 14 is moved such that a third film can be fed.

When state of the upstream side leading and back ends detecting sensor 30 is changed from OFF to ON (Step S15), the negative film reservoir 18 stops conveyance of the second film in order to prevent the second film from bumping the first film (Step S16). Changing of the state of the upstream side leading and back ends detecting sensor 30 from OFF to ON means the leading end of the film arriving the upstream side leading and back ends detecting sensor 30.

When the step 8 is carried out, this information is transmitted to the negative film feeder 26, and the negative film feeder 26 starts conveyance of the second film again (Step S17). When state of the downstream side leading and back ends detecting sensor 32 is changed from OFF to ON (Step S18), the negative film feeder 26 stops conveyance of the second film in order to prevent the second film from bumping the first film (Step S19).

When the step 11 is carried out, the negative film feeder 26 starts conveyance of the film again (Step S20), and the second film is sent from the negative film feeder 26 to the carrier 65. Then, scanning of the film is carried out (Step S21).

Further, state of the upstream side leading and back ends detecting sensor 30 is changed from ON state to OFF state (Step S22).

Further, state of the downstream side leading and back ends detecting sensor 32 is changed from ON state to OFF state (Step S23)

Thereafter, when state of the carrier inside sensor 46 is changed from ON to OFF (Step S24), then, the second film is fed to the negative film catcher 50 (Step S25). When state of the feeding trigger sensor 56 is changed from ON to OFF (Step S26) then, the second film is accommodated in the negative film receiving box 54 (Step S27).

On the other hand, when the step 22 is carried out, this information is transmitted to the negative film setter 12, and the negative film setter 12 feeds the third film to the negative film reservoir 18 (Step S28). At this time, all of perforations are detected (Step S29). When state of the upstream side leading and back ends detecting sensor 30 is changed from OFF to ON (Step S30), the negative film reservoir 18 stops conveyance of the third film in order to prevent the third film from bumping the second film (Step S31).

When the step S23 is carried out, this information is transmitted to the negative film feeder 26, and the negative film feeder 26 starts conveyance of the third film again (Step S32). When state of the downstream side leading and back ends detecting sensor 32 is changed from OFF to ON (Step S33). The negative film feeder 26 stops conveyance of the film (Step S34).

Further, when the step S26 is carried out, the negative film feeder 26 starts conveyance of the film again, and the third film is sent from the negative film feeder 26 to the carrier 65 (Step S35).

Thereafter, the third film is accommodated in the negative film receiving box 54 in the similar way of the first and the second films.

Thereafter, in the similar way, films set at the negative film setter 12 are sequentially conveyed, and the films are accommodated in the negative film receiving box 54 after images thereof are read.

As described above, in the present embodiment, when the plurality of the films set at the negative film setter 12 are conveyed, by detection by the upstream side leading and back ends detecting sensor 30, the downstream side leading and back ends detecting sensor 32 and the feeding trigger sensor 56, conveyance of the subsequent film is started or re-started after the back end of the leading film passes therethrough. As a result, the films can be sequentially conveyed efficiently and such that the films do not bump each other. Instead of those sensors detecting that back end of the film finishes passing therethrough, those sensors may detect a perforation formed at the most back end of the film.

Further, in the present embodiment, with using the negative film setter 72 (see FIG. 6) explained in the third embodiment, pre-scanning may be carried out at the pre-scanning section 71.

As described above, the embodiments of the present have been explained. However, those embodiments are examples, and it will be appreciated that numerous changes and modifications are likely to occur, and it is intended to cover all changes and modifications which fall within the scope of the invention. Further, the scope of the present invention is not limited to the embodiments and the examples described above. For example, not only a negative film but also films of other types can be applied.

Because the present invention has structure described above, an image reading apparatus by which time required to input images of a film is reduced can be realized.

What is claimed is:

1. An image reading apparatus comprising:
a film set section at which a film is set and from which the set film is fed;
a first detecting section which detects starting positions of respective frame images of the film fed from the film set section, and positions of marks formed outside the respective frame images;
a storing section which sets and stores, on the basis of the starting positions of the respective frame images and the positions of the marks detected by the first detecting section, a position of a frame corresponding mark, which corresponds to the starting position, every each of the frame images;
a second detecting section, provided at downstream side of the first detecting section, which detects the position of the frame corresponding mark every each of the frame images; and
an image reading section which reads each of the image frames in order of frame number thereof on the basis of the stored contents in the storing section and detection data detected by the second detecting section.

2. An image reading apparatus according to claim 1, wherein the storing section estimates and stores a starting position of a frame image which cannot be detected by the first detecting section, and a position of a frame corresponding mark which corresponds to the starting position of the frame image which cannot be detected by the first detecting section, on the basis of a starting position of a frame image of the film, which can be detected by the first detecting section, and a position of a frame corresponding mark which corresponds to the starting position of the frame image which can be detected by the first detecting section.

3. An image reading apparatus according to claim 1, wherein the mark formed outside the frame image is a perforation formed at the film.

4. An image reading apparatus according to claim 2, wherein the mark formed outside the frame image is a perforation formed at the film.

5. An image reading apparatus according to claim 1 further comprising a determining section which judges at least one of direction of a surface of the film and type of the film.

6. An image reading apparatus according to claim 2 further comprising a determining section which judges at least one of direction of a surface of the film and type of the film.

7. An image reading apparatus according to claim 5, wherein the determination is made by the determining section by detecting a bar code provided at the film.

8. An image reading apparatus according to claim 6, wherein the determination is made by the determining section by detecting a bar code provided at the film.

9. An image reading apparatus according to claim 5, wherein the determination is made by the determining section by detecting silver on the film with infrared light.

10. An image reading apparatus according to claim 7, wherein the determination is made by the determining section by detecting silver on the film with infrared light.

11. An image reading apparatus according to claim 1 further comprising a pre-scanning section, provided at upstream side of the image reading section, which carries out a pre-scanning of the film.

12. An image reading apparatus according to claim 2 further comprising a pre-scanning section, provided at upstream side of the image reading section, which carries out a pre-scanning of the film.

13. An image reading apparatus comprising:
a film set section at which a film is set and from which the set film is fed;
a first detecting section which detects starting positions of respective frame images of the film fed from the film set section, and positions of marks formed outside the respective frame images;
a storing section which sets and stores, on the basis of the starting positions of the respective frame images and the positions of the marks detected by the first detecting section, a position of a frame corresponding mark, which corresponds to the starting position, every each of the frame images;
a second detecting section, provided at downstream side of the first detecting section, which detects the position of the frame corresponding mark every each of the frame images; and
an image reading section which reads each of the image frames, without the film being conveyed to the reverse direction, on the basis of the stored contents in the storing section and detection data detected by the second detecting section.

14. An image reading apparatus according to claim 13, wherein the storing section estimates and stores a starting position of a frame image which cannot be detected by the first detecting section, and a position of a frame corresponding mark which corresponds to the starting position of the frame image which cannot be detected by the first detecting section, on the basis of a starting position of a frame image of the film, which can be detected by the first detecting section, and a position of a frame corresponding mark which corresponds to the starting position of the frame image which can be detected by the first detecting section.
